(19) United States
(12) Patent Application Publication
(10) Pub. No.: US 2026/0079634 A1
(43) Pub. Date: Mar. 19, 2026

(54) INFORMATION PROCESSING SYSTEM AND MEMORY SYSTEM

(71) Applicant: Kioxia Corporation, Tokyo (JP)

(72) Inventor: Ayumi HARA, Yokohama Kanagawa (JP)

(21) Appl. No.: 19/067,480

(22) Filed: Feb. 28, 2025

(30) Foreign Application Priority Data
Sep. 19, 2024 (JP) 2024-162488

(51) Int. Cl. G06F 3/06

(52) U.S. Cl. CPC G06F 3/0634; G06F 3/0613; G06F 3/0659; G06F 3/0679

(57) ABSTRACT

A memory system includes a non-volatile memory having a plurality of blocks, and a memory controller. The memory controller is configured to set one of writing modes including a first mode of writing a single bit of data per memory cell and a second mode of writing multi bits of data per memory cell as a data writing mode for each of one or more blocks, upon receiving information indicating a size of write data to be written into the non-volatile memory from a host device, determine whether the size exceeds a size of a first free space of the non-volatile memory usable for data writing in the first writing mode, and upon determining that the size of the write data exceeds the size of the first free space, write at least a part of the write data into the non-volatile memory in the second writing mode.

### CROSS-REFERENCE TO RELATED APPLICATION

This application is based upon and claims the benefit of priority from Japanese Patent Application No. 2024-162488, filed Sep. 19, 2024, the entire contents of which are incorporated herein by reference.

### FIELD

Embodiments described herein relate generally to an information processing system and a memory system.

### BACKGROUND

In recent years, a memory system with a non-volatile memory has become widespread. In the memory system, for example, a NAND flash memory is used as the non-volatile memory. In such a memory system, a multi-level technology for achieving a large storage capacity is introduced.

### BRIEF DESCRIPTION OF THE DRAWINGS

FIG. 1 is a block diagram showing a configuration of an information processing system according to a first embodiment.

FIG. 2 is a block diagram showing a configuration of a memory provided in the information processing system according to the first embodiment.

FIG. 3 is a perspective view diagram showing a configuration of a memory cell array according to the first embodiment.

FIG. 4 is a cross-sectional view diagram showing a configuration of the memory cell according to the first embodiment.

FIG. 5 is a circuit diagram showing a configuration of the memory cell array according to the first embodiment.

FIG. 6 is a flowchart showing a write performance optimization processing method of the information processing system according to the first embodiment.

FIG. 7 is a diagram showing an example of an operation sequence of the information processing system according to the first embodiment.

FIG. 8 is a diagram showing an example of an operation sequence of an information processing system according to a modification example.

FIG. 9 is a diagram showing an example of the operation sequence of the information processing system according to a second embodiment.

### DETAILED DESCRIPTION

Embodiments provide an information processing system and a memory system with improved write performance.

In general, according to an embodiment, a memory system includes a non-volatile memory having a plurality of blocks, each of the blocks including a plurality of memory cells, and a memory controller. The memory controller is configured to set one of a plurality of writing modes including a first writing mode of writing a single bit of data per memory cell and a second writing mode of writing multi bits of data per memory cell as a data writing mode for each of one or more blocks of the non-volatile memory, upon receiving information indicating a size of write data to be written into the non-volatile memory from a host device, determine whether the size of the write data exceeds a size of a first free space of the non-volatile memory usable for data writing in the first writing mode, and upon determining that the size of the write data exceeds the size of the first free space, write at least a part of the write data into the non-volatile memory in the second writing mode.

In the following, the information processing system and the memory system of each embodiment or modification thereof will be described with reference to the drawings. In the following description, elements having the same or similar function and configuration are given by common reference numerals. When distinguishing a plurality of elements having common reference numerals, the elements may be distinguished by adding subscripts (for example, capital letters of the alphabet, numbers, and hyphens and capital letters of the alphabet and numbers) to the common reference numerals, and duplicate descriptions may be omitted.

### First Embodiment

### 1-1. Overall Configuration of Information Processing System

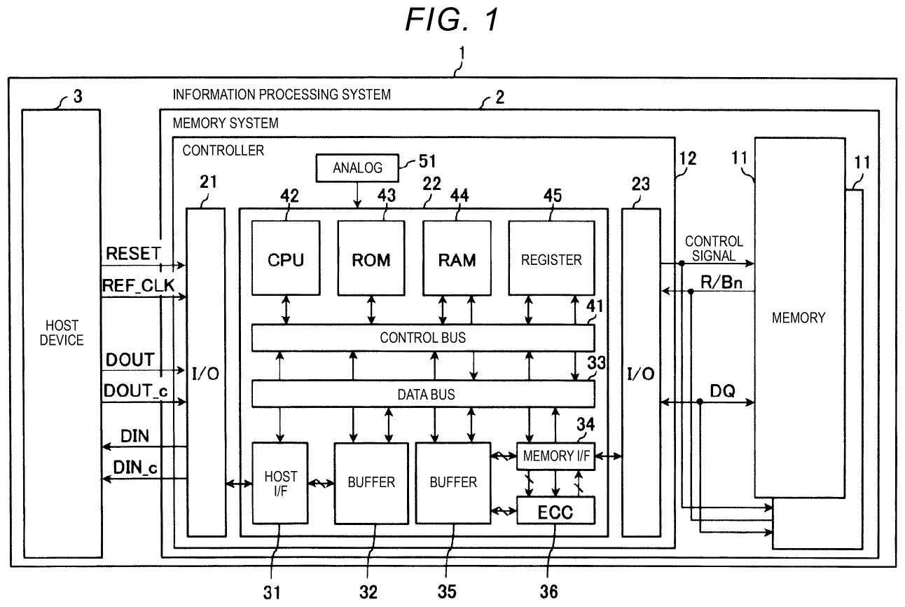

The overall configuration of an information processing system 1 including a memory system according to a first embodiment will be described with reference to FIG. 1. FIG. 1 is a block diagram showing a configuration of the information processing system 1. The information processing system 1 includes a memory system 2 and a host device 3. The memory system is commonly referred to as either a memory device or a memory card.

The memory system 2 is configured to communicate with the host device 3 based on a client-server model. The memory system 2 operates as a target, and the host device 3 operates as an initiator. As a more specific example, the memory system 2 is a Universal Flash Storage (UFS) memory device, and the host device 3 is a host device that supports the UFS memory device. The host device 3 may be, for example, a system on chip (SoC) device, and may be a device mounted on a smartphone, a digital camera, or the like.

The memory system 2 includes a plurality of non-volatile semiconductor memories 11 (hereinafter, referred to as “memory”) and a controller 12 for controlling the memories 11. The controller 12 controls each of the plurality of memories 11.

The memory 11 performs a data write operation and a data read operation in a specific write unit configured with a plurality of bits. Further, the memory 11 erases data in erasing units each configured with a plurality of write units. For example, the memory 11 is configured with one or a plurality of NAND flash memories. Each NAND flash memory includes a plurality of blocks, and each block includes a plurality of pages. When the memory 11 is a NAND flash memory, the memory 11 performs a write operation and a read operation in units of pages, and an erase operation is performed in units of blocks.

When a write mode of a memory cell is a single level cell (SLC), one page is configured with a plurality of memory cells connected to one word line. When the write mode of the memory cell is multi level cell (MLC), two pages (2 bits (2² levels, 4 values)) are configured with the plurality of memory cells connected to one word line, when the write mode of the memory cell is triple level cell (TLC), three pages (3 bits (2³ levels, 8 values)) are configured with the plurality of memory cells connected to one word line, and when the write mode of the memory cell is quad level cell (QLC), four pages (4 bits (2⁴ levels, 16 values)) are configured with the plurality of memory cells connected to one word line. When the memory cell is a multi-bit cell, one memory cell is set to a multi-bit threshold voltage to correspond to a plurality of pages.

The capacity of the memory cell depends on the write mode (number of bits) of the memory cell. The capacity of the memory cell increases as the number of bits increases. The capacity of the memory cell is larger for MLC than for SLC, larger for TLC than for MLC, and larger for QLC than for TLC. The write mode of the memory cell is set in units of blocks. The write mode of each block is set to any one of SLC, MLC, TLC, and QLC.

The write speed of the memory cell depends on the write mode (number of bits) of the memory cell. The write speed of the memory cell decreases as the number of bits increases. The write speed of the memory cell is smaller for MLC than for SLC, smaller for TLC than for MLC, and smaller for QLC than for TLC.

In general, for data writing to the memory 11, when the memory 11 includes QLC (4 bits/cell) memory cells, data may be written in the QLC from the beginning. In order to improve the response performance to the host device 3, since the write speed is slow in the QLC, the write data transferred from the host device 3 may be once written in the SLC, and then the data written in the SLC may be written in another block in the QLC. In addition, depending on the size of the write data and the free state of the free block, which will be described below, it is necessary to allocate a free block through garbage collection (GC) or compaction processing, which will be described below, due to insufficient free blocks, and as a result, writing may take time. Such a general method of writing data to the memory 11 is also referred to as writing in a write normal mode, in which case the host device 3 may not designate the write mode. In the present embodiment, in addition to writing in the write normal mode, it is possible to select writing in a write optimization mode in order to execute data writing in a more optimal write method according to the size of write data.

In the following, a case where the memory 11 is a three-dimensional stacked NAND flash memory in which memory cell transistors are three-dimensionally stacked above a semiconductor substrate will be described. The memory is not limited to a three-dimensional stacked NAND flash memory, and may be a planar NAND flash memory in which memory cell transistors are two-dimensionally disposed on a semiconductor substrate, or may be another non-volatile memory. Details of the memory 11 will be described below.

The memory system 2 includes an I/O 21, a core logic unit 22, and an I/O 23. The I/O 21 includes a hardware configuration for the memory system 2 to be connected to the host device 3. The memory system 2 is connected to the host device 3 via a host bus. When the information processing system 1 complies with a Universal Flash Storage (UFS) standard, the host bus corresponds to a serial interface. Signals communicated between the memory system 2 and the host device 3 include RESET, REF_CLK, DOUT, DOUT_c, DIN, and DIN_c. The RESET, REF_CLK, DOUT, DOUT_c, DIN, and DIN_c are communicated between the host device 3 and the I/O 21 via the host bus. The RESET is a hardware reset signal. REF_CLK is a reference clock signal. The DOUT and DOUT_c are signals forming a differential signal pair and transmitted from the host device 3 to the memory system 2. The DIN and DIN_c are signals forming a differential signal pair and are transmitted from the memory system 2 to the host device 3.

The core logic unit 22 is a main part of the controller 12 except for the I/O 21 and the I/O 23. The I/O 23 includes a hardware configuration for the controller 12 to be connected to the memory 11.

The core logic unit 22 includes a host interface 31, a buffer 32, a data bus 33, a memory interface 34, a buffer 35, an error correcting code (ECC) circuit 36, a control bus 41, a central processing unit (CPU) 42, a read only memory (ROM) 43, a random access memory (RAM) 44, and a register 45.

The I/O 21 is connected to the host interface 31. The host interface 31 performs processing necessary for communication between the memory system 2 and the host device 3. More specifically, the host interface 31 is responsible for communication between the memory system 2 and the host device 3, in accordance with a communication protocol with which both the memory system 2 and the host device 3 comply. When the memory system 2 is a UFS memory device, for example, the host interface 31 is a UFS interface. The UFS interface complies with an M-PHY standard for the physical layer and complies with a UniPro standard for the link layer.

The host interface 31 is connected to the buffer 32. The buffer 32 receives data transmitted from the host device 3 to the memory system 2 via the host interface 31 and temporarily stores the data. In addition, the buffer 32 temporarily stores data transmitted from the memory system 2 to the host device 3 via the host interface 31. The buffer 32 is connected to the data bus 33.

The I/O 23 is connected to the memory interface 34. The memory interface 34 performs processing necessary for the controller 12 to communicate with the memory 11. More specifically, the memory interface 34 transmits instructions (control signals) from the core logic unit 22 in a form that is recognizable by the memory 11. Further, the memory interface 34 communicates a signal DQ with the memory 11 and receives a ready/busy signal R/Bn from the memory 11. The signal DQ includes, for example, data, an address, and a command. The signal R/Bn is a signal indicating that the memory 11 is in a busy state. When the memory 11 is a NAND flash memory, the memory interface 34 is a NAND flash interface.

The memory interface 34 is connected to the buffer 35. The buffer 35 receives data transmitted from the memory 11 to the controller 12 via the memory interface 34, and temporarily stores the data. In addition, the buffer 35 temporarily stores data scheduled to be transmitted from the controller 12 to the memory 11 via the memory interface 34. The buffer 35 is connected to the data bus 33. The buffers 32 and 35 may be one buffer. The memory interface 34 and the buffer 35 are connected to the ECC circuit 36. The ECC circuit 36 receives write data from the host device 3 via the data bus 33, adds an error correction code (hereinafter, referred to as “parity”) to the write data, and supplies the write data to which the parity is added to the buffer 35. In addition, the ECC circuit 36 receives the data supplied from the memory 11 via the buffer 35, performs error correction using the parity added to the data, and supplies the error-corrected data to the data bus 33.

The CPU 42, the ROM 43, the RAM 44, and the register 45 are connected to the control bus 41. The CPU 42, the ROM 43, the RAM 44, and the register 45 communicate with each other via the control bus 41.

The CPU 42 controls the overall operation of the memory system 2. The CPU 42 executes predetermined processing (e.g., write operation, read operation, erase operation, or the like) in accordance with a control program (instruction) stored in the ROM 43. For example, the CPU 42 executes predetermined processing on the memory 11 in accordance with a command received from the host device 3.

When the CPU 42 receives a read request (instruction) including a command and a logical address from the host device 3, the CPU 42 reads logical-to-physical address conversion data corresponding to the logical address which is a read target from an address conversion table (look-up table LUT) in which the logical address and the physical address are associated with each other and which is stored in the memory 11, and converts the logical address into the physical address. The physical address specifies a part of a memory space of the memory 11. The read operation for reading read data from the physical address is instructed to the memory I/F 34. In addition, when the CPU 42 receives a write request including a command, write data, and the logical address from the host device 3, the CPU 42 assigns a physical address corresponding to the logical address to the logical address in a new manner and manages the look-up table LUT. The write operation for writing write data to the physical address is instructed to the memory I/F 34.

In addition, the CPU 42 executes garbage collection (GC) processing. The garbage collection (GC) is processing for increasing the number of available blocks in the physical block, and means, for example, processing of collecting valid data from a plurality of active blocks in which valid data and invalid data are included, rewriting the valid data to another block, and allocating a free block. Here, the active block is referred to as a physical block in which valid data is recorded. The free block is referred to as a physical block in which valid data is not recorded. After erasing, the free block is reusable as an erased block. The free block includes both a block before erasing in which valid data is not recorded and an erased block. The valid data is data associated with a logical address, which will be described below, and the invalid data is data not associated with the logical address. The erased block is recategorized as an active block when data is written. For example, the CPU 42 counts the number of free blocks, and when the number of free blocks is equal to or less than a predetermined threshold value, the CPU 42 executes the GC. When the number of free blocks is greater than the predetermined threshold value, the CPU 42 may not execute the GC processing.

The CPU 42 also manages the capacity of the free area of the memory cell array 108. For example, the free capacity of the active blocks in each write mode and the capacity of the free blocks are acquired from the memory 11 and managed. The CPU 42 stores a write mode, free capacity, and capacity of the free blocks for a specific block together with a physical address of each block in the RAM 44. That is, the RAM 44 has a function as a capacity counter in which the capacity information is stored. The CPU 42 manages the capacity information by updating the capacity counter in response to the execution of a write operation and an erase operation. In other words, the CPU 42 updates the capacity counter based on the capacity information. The capacity counter manages the physical address of the block and the free capacity of the blocks in each write mode in association with each other.

The ROM 43 stores a control program to be executed by the CPU 42 and the like. The programs and the like stored in the ROM 43 are read out and are executed by the CPU 42, as necessary.

The RAM 44 is used as a work area of the CPU 42 and temporarily stores variables (e.g., write data, read data, and the like) necessary for the operation of the CPU 42. Further, the RAM 44 may be provided with a storage area for various values used during processing (for example, a physical address of a block and a free capacity in the block for each write mode) and various tables (for example, a look-up table LUT). The RAM 44 may be provided outside the controller 12.

The register 45 stores various values necessary for the operation of the memory system 2. In addition, the register 45 stores various values necessary for the host device 3 to control the memory system 2. The register 45 stores, for example, a write data amount (dWriteDataSize) to be written by the host device 3.

Further, the host interface 31, the buffer 32, the memory interface 34, and the buffer 35 are connected to the control bus 41. The CPU 42 controls the host interface 31, the buffer 32, the memory interface 34, and the buffer 35 based on instructions from the control program or the host device 3. Further, the controller 12 may be provided with an analog circuit 51 that functions for example, as a voltage regulator that supplies a stabilized voltage.

### 1-2. Configuration of Memory

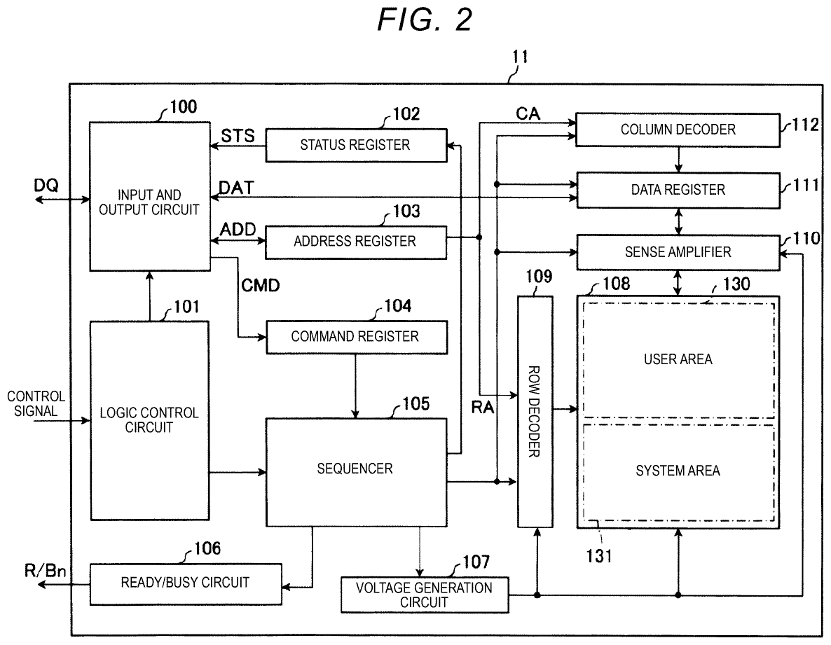

The configuration of the memory 11 will be described with reference to FIG. 2. FIG. 2 is a block diagram showing the configuration of the memory 11 provided in the information processing system according to the present embodiment. In FIG. 2, some of the connection between the blocks are indicated by arrow lines, but the connections between the blocks are not limited to the arrow lines shown in FIG. 2.

As shown in FIG. 2, the memory 11 includes an input and output circuit 100, a logic control circuit 101, a status register 102, an address register 103, a command register 104, a sequencer 105, a ready/busy circuit 106, a voltage generation circuit 107, a memory cell array 108, a row decoder 109, a sense amplifier 110, a data register 111, and a column decoder 112.

The input and output circuit 100 controls input and output of the signal DQ that is communicated with the controller 12. More specifically, the input and output circuit 100 transmits data DAT (write data) received from the controller 12 to the data register 111, transmits an address ADD to the address register 103, and transmits a command CMD to the command register 104. Further, the input and output circuit 100 transmits status information STS received from the status register 102, the data DAT (read data) received from the data register 111, and the address ADD received from the address register 103 to the controller 12.

The logic control circuit 101 receives various control signals from the controller 12. The logic control circuit 101 controls the input and output circuit 100 and the sequencer 105 in accordance with the received control signal.

The status register 102 temporarily stores, for example, the status information STS in a write operation, a read operation, and an erase operation, and notifies the controller 12 of whether the operation is completed normally.

The address register 103 temporarily stores the address ADD received from the controller 12 via the input and output circuit 100. The address register 103 transfers a row address RA to the row decoder 109 and transfers a column address CA to the column decoder 112.

The command register 104 temporarily stores the command CMD received from the controller 12 via the input and output circuit 100 and transfers the command CMD to the sequencer 105.

The sequencer 105 controls the operation of the entire memory 11. More specifically, the sequencer 105 controls, for example, the status register 102, the ready/busy circuit 106, the voltage generation circuit 107, the row decoder 109, the sense amplifier 110, the data register 111, the column decoder 112, and the like in response to the command CMD stored in the command register 104, and executes the write operation, the read operation, the erase operation, and the like.

The ready/busy circuit 106 transmits the ready/busy signal R/Bn to the controller 12 in response to an operation status of the sequencer 105.

The voltage generation circuit 107 generates a voltage necessary for a write operation, a read operation, and an erase operation in response to the control of the sequencer 105, and supplies the generated voltage to, for example, the memory cell array 108, the row decoder 109, the sense amplifier 110, and the like. The row decoder 109 and the sense amplifier 110 apply the voltage supplied from the voltage generation circuit 107 to memory cell transistors in the memory cell array 108.

The memory cell array 108 includes a plurality of non-volatile memory cell transistors (In the following, also referred to as “memory cells”) associated with rows and columns. The memory cell array 108 includes a user area 130 and a system area 131 as spatial areas of the memory.

The user area 130 is an area in which write and read data (hereinafter, referred to as “user data”) of data received from the host device 3 is stored. It is preferable that the user area 130 is allocated to a range other than ¼ from a head of the logical address.

The system area 131 is, for example, an area in which information (hereinafter, referred to as “system data”) for managing the memory system 2, such as a control program in the memory 11, logical-to-physical address conversion data, or various setting parameters such as an applied voltage in a write operation, is stored. The system area 131 is an area to which the host device 3 does not have access in a write operation and a read operation of data received from the host device 3. It is preferable that the system area 131 is allocated to a range within ¼ from the head of the logical address.

The row decoder 109 decodes the row address RA. The row decoder 109 applies a predetermined voltage to the memory cell array 108, based on the decoding result.

The sense amplifier 110 senses data read from the memory cell array 108 during the read operation. The sense amplifier 110 outputs the read data to the data register 111. In addition, the sense amplifier 110 writes write data to the memory cell array 108 during the write operation.

The data register 111 includes a plurality of latch circuits. The latch circuit temporarily stores write data or read data. For example, in the write operation, the data register 111 temporarily stores the write data received from the input and output circuit 100 and transmits the write data to the sense amplifier 110. For example, in the read operation, the data register 111 temporarily stores the read data received from the sense amplifier 110 and transmits the read data to the input and output circuit 100.

The column decoder 112 decodes the column address CA, for example, during a write operation, a read operation, and an erase operation, and selects the latch circuit in the data register 111 according to the decoding result.

### 1-3. Configuration of Memory Cell Array

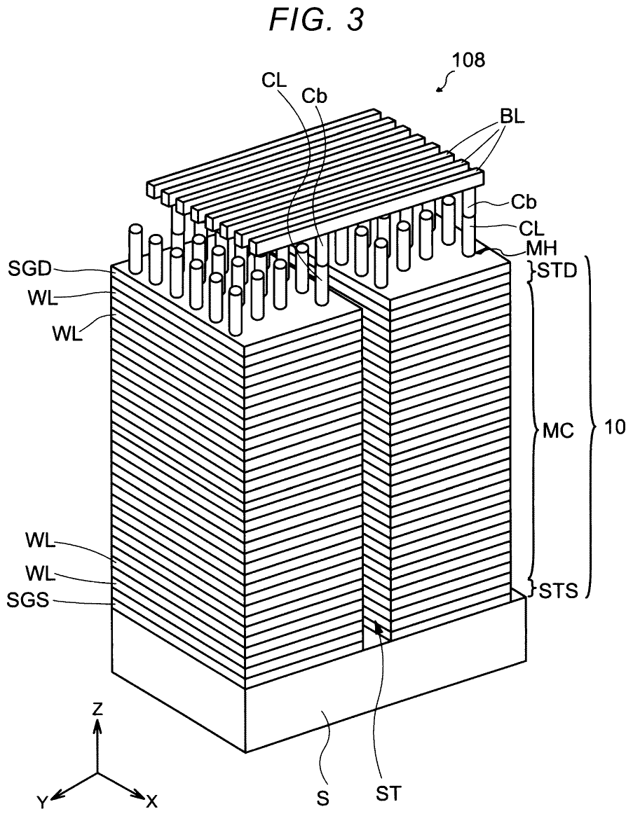

The configuration of the memory cell array 108 will be described with reference to FIG. 3. FIG. 3 is a schematic perspective view diagram showing the disposition of each element of the memory cell array 108 according to the present embodiment.

In FIG. 3, two directions that are parallel to a main surface of a substrate S and orthogonal to each other are referred to as an X direction and a Y direction, and a plane parallel to the main surface of the substrate S is referred to as an XY plane. A direction orthogonal to both the X direction and the Y direction is referred to as a Z direction (stacking direction).

As shown in FIG. 3, the memory cell array 108 has the substrate S, a stacked body 10 provided on the substrate S, a plurality of columnar body portions CL, and a plurality of bit lines BL provided on the stacked body 10.

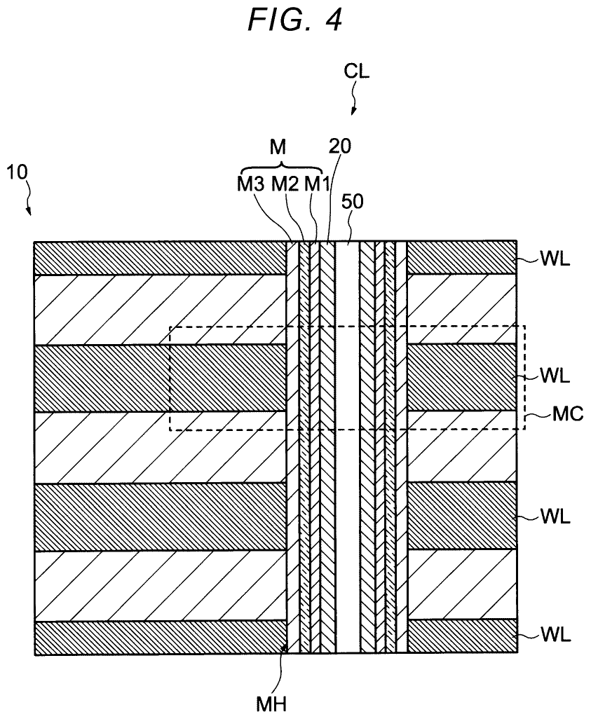

The stacked body 10 includes a plurality of conductive layers that are insulated from each other and periodically stacked in a direction (stacking direction) perpendicular to the main surface of the substrate S, and corresponds to a select gate line SGS, a plurality of word lines WL, and a select gate line SGD from a substrate side. The stacked body 10 is provided with openings ST and MH. The openings ST and MH extend in the stacking direction (Z direction) and reach the substrate S by penetrating the stacked body 10. The opening ST extends in the X direction and separates the stacked body 10 into a plurality of blocks in the Y direction. The opening MH is provided with the columnar body portion CL (refer to FIG. 4).

The columnar body portion CL is formed in a cylindrical shape extending in the stacking direction in the stacked body 10. The plurality of columnar body portions CL are, for example, arranged in a staggered manner. Alternatively, the plurality of columnar body portions CL may be arranged in a square grid pattern along the X direction and the Y direction.

The plurality of bit lines BL are separated from each other in the X direction, and each bit line BL extends in the Y direction.

An upper end of a semiconductor layer 20 (refer to FIG. 4), which will be described below, of the columnar body portion CL is connected to the bit line BL via a contact portion Cb. The plurality of columnar body portions CL, which are selected one by one from each of the blocks separated in the Y direction by the opening ST, are connected to one common bit line BL.

An insulating layer is formed between two word lines that are adjacent to each other in the stacking direction. An insulating layer is formed in a slit ST, and an insulating layer is formed on the stacked body 10. However, these insulating layers are omitted in FIG. 3 for convenience of description.

FIG. 4 is a cross-sectional view diagram showing a configuration of the memory cell according to the present embodiment. FIG. 4 illustrates an enlarged sectional view of the columnar body portion CL in FIG. 3.

As shown in FIG. 4, the columnar body portion CL is a structure having a memory layer M, the semiconductor layer 20, and an insulating core layer 50. The semiconductor layer 20 continuously extends in the stacking direction (Z direction) in the stacked body 10. The material of the semiconductor layer 20 contains amorphous or polycrystalline silicon, for example. The core layer 50 is provided inside the cylindrical semiconductor layer 20. The material of the core layer 50 contains silicon oxide, for example. The memory layer M is provided between the word line WL and the semiconductor layer 20. The memory layer M surrounds the semiconductor layer 20 from an outer periphery side of the semiconductor layer 20.

The memory layer M has a tunnel insulating layer M1, a charge storage layer M2, and a block insulating layer M3 (here, the memory layer M is referred to when the tunnel insulating layer M1, the charge storage layer M2, and the block insulating layer M3 are not distinguished). The block insulating layer M3, the charge storage layer M2, and the tunnel insulating layer M1 continuously extend in the stacking direction of the stacked body 10 together with the semiconductor layer 20. The block insulating layer M3, the charge storage layer M2, and the tunnel insulating layer M1 are provided in this order between the word line WL and the semiconductor layer 20 from a word line WL side. The tunnel insulating layer M1 is in contact with the semiconductor layer 20. The block insulating layer M3 is in contact with the word line WL. The charge storage layer M2 is provided between the block insulating layer M3 and the tunnel insulating layer M1.

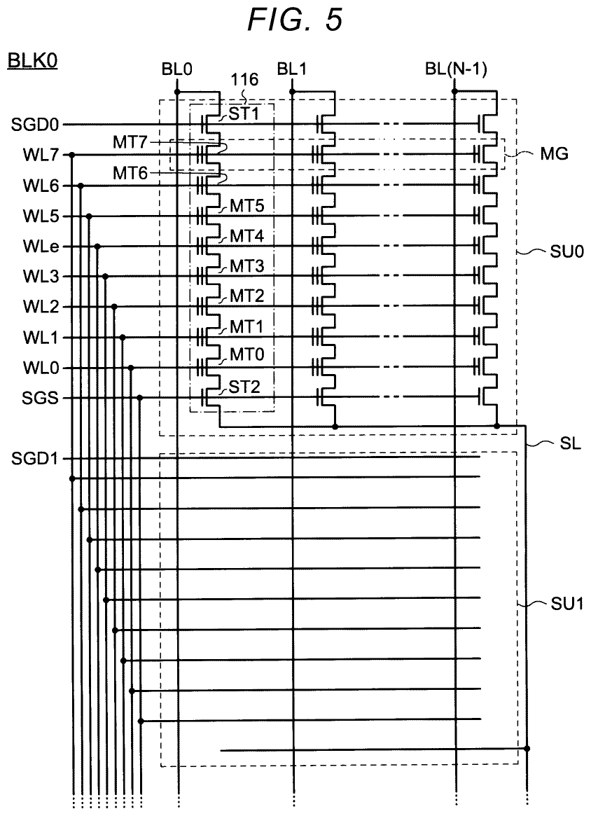

The semiconductor layer 20, the memory layer M, and the word line WL configure a memory cell MC. In FIG. 5, one memory cell MC is schematically represented by a broken line. The memory cell MC has a vertical transistor structure in which the semiconductor layer 20 is surrounded by the word line WL through the memory layer M.

In the memory cell MC having the vertical transistor structure, the semiconductor layer 20 functions as a channel, and the word line WL functions as a control gate of the memory cell. The charge storage layer M2 functions as a data layer that stores the charges injected from the semiconductor layer 20.

As described above, a plurality of memory cells MC are arranged in the stacking direction of the plurality of word lines WL, and the plurality of word lines WL are connected to the plurality of memory cells MC, respectively. The word line WL in the vicinity of the block insulating layer M3 functions as a control gate. By controlling the voltage to the word line WL connected to the memory cell MC, it is possible to control writing to or erasing of the memory cell MC.

The memory cell MC is, for example, a charge trap type memory cell. The charge storage layer M2 has a large number of trap sites for capturing charges in the insulating layer. The material of the charge storage layer M2 contains silicon nitride, for example.

The tunnel insulating layer M1 serves as a potential barrier when charges are injected from the semiconductor layer 20 into the charge storage layer M2 or when the charges stored in the charge storage layer M2 diffuse in a direction of the semiconductor layer 20. The material of the tunnel insulating layer M1 contains silicon oxide, for example.

The block insulating layer M3 prevents the charge stored in the charge storage layer M2 from diffusing to the word line WL. The material of the block insulating layer M3 contains silicon oxide, for example.

FIG. 5 is a circuit diagram of a block BLK provided in the memory cell array 108 of the memory 11. A block BLK0 will be described as an example, but other blocks BLK1, 2, . . . are also the same circuits. The circuit diagram shown in FIG. 5 is an example and does not limit the circuit diagram of the memory cell array 108 of the first embodiment. In the description of the memory cell array 108, the description of the same or similar configuration as in FIGS. 1 to 4 may be omitted.

The block BLK0 includes N bit lines BL (BL0, BL1, . . . , and BL(N-1)) (N is an integer of 2 or more) arranged in a row, a plurality of NAND strings 116 arranged in a matrix, and a source line SL. The NAND string 116 is connected between the N bit lines BL and the source line SL. The NAND string 116 includes, for example, eight memory cell transistors MT (MT0 to MT7) and select transistors ST1 and ST2. The memory cell transistor MT includes a control gate and a charge storage layer and stores data in a non-volatile manner. The memory cell transistor MT is connected in series between a source of the select transistor ST1 and a drain of the select transistor ST2. The NAND strings 116 are provided on the N bit lines BL, and thus string units SU (SU0, SU1) are configured. In FIG. 5, the NAND string 116 includes, for example, eight memory cell transistors MT, but the number of memory cell transistors MT provided in the NAND string 116 is not limited to eight. For example, the number of memory cell transistors MT may be i, and the integer i may be greater than 8 or may be less than 8.

The select transistor ST1 is connected to a select gate line SGD0. The gate of the select transistor ST1 in each of the string units SU is connected to each of the select gate lines SGD (SGD0, SGD1, . . . , here, when the plurality of SGD0, SGD1, . . . are not distinguished from each other, they are collectively referred to as a select gate line SGD). The gates of the eight memory cell transistors MT (MT0 to MT7) are connected to the corresponding word lines WL (WL0 to WL7), respectively. In addition, the gate of the select transistor ST2 in each of the string units SU is connected to a select gate line SGS. The gates of the select transistors ST1 in the same string unit SU that are respectively connected to the plurality of bit lines BL are connected to the common select gate line SGD. The gates of the memory cell transistors MT (MT0 to MT7) in the same string unit SU are connected to the respective common word lines WL (WL0 to WL7). The gates of the plurality of select transistors ST2 in the same block BLK are connected to a common select gate line SGS. The source line SL is shared among, for example, the plurality of blocks BLK.

In the same string unit SU, the memory cell transistors MT connected to the same word lines WL (WL0 to WL7) configure the unit of the read operation and the write operation. For example, the memory cell transistor MT7 in each of the NAND strings 116 provided in the string unit SU corresponding to the select gate line SGD0 configures a memory cell group MG as the unit of the read operation and the write operation, and the read operation and the write operation are collectively executed for the memory cell group MG.

### 1-4. Write Performance Optimization Processing

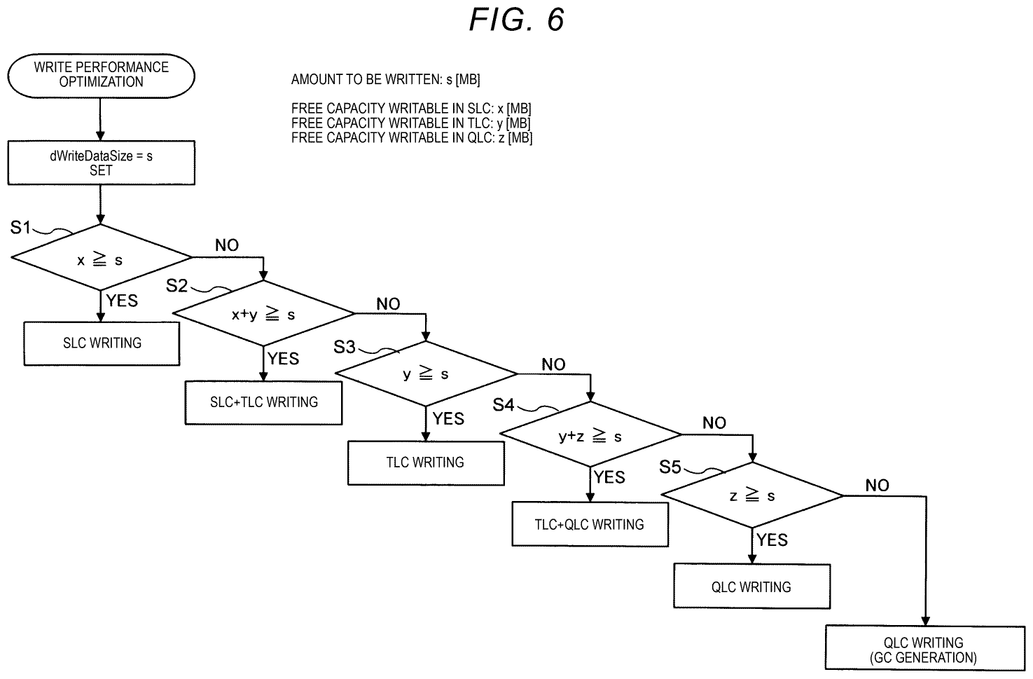

The write performance optimization processing will be described with reference to FIG. 6. FIG. 6 is a flowchart showing a write performance optimization processing method of the information processing system 1 according to the present embodiment. In the write performance optimization, the write data amount (s[MB]) scheduled to be written is compared with the free capacity of the memory cell array 108, and an optimal write mode is determined. The free capacity of the memory cell array 108 includes, for example, free capacity that is writable in the SLC (x[MB]), free capacity that is writable in the TLC (y[MB]), and free capacity that is writable in the QLC (z[MB]). The free capacity that is writable in each write mode indicates the capacity that is writable when a certain write mode is fixed. For example, the free capacity that is writable in each write mode indicates the sum of the capacity of the pages in which valid data is not recorded in each active block and the capacity of the free blocks in each write mode. However, the present disclosure is not limited to this, and the free capacity of the active blocks in which the write mode is fixed may be used when the free capacity is equal to or greater than a predetermined value, the free capacity of the active blocks may not be used, and the free capacity of the free blocks may be used when the free capacity is equal to or greater than the predetermined value at the time of writing.

First, it is determined whether the write data amount (s[MB]) is writable in the SLC (Step S1). When the write data amount (s[MB]) is equal to or less than the free capacity (x[MB]) that is writable in the SLC (x≥s) (YES in Step S1), the write mode is determined to be the SLC. On the other hand, when the write data amount (s[MB]) is greater than the free capacity (x[MB]) that is writable in the SLC (NO in Step S1), the process proceeds to the next step.

Next, it is determined whether the write data amount (s[MB]) is writable in the SLC and the TLC (Step S2). When the write data amount (s[MB]) is equal to or less than the sum of the free capacity (x[MB]) that is writable in the SLC and the free capacity (y[MB]) that is writable in the TLC (x+y≥s) (YES in Step S2), the write mode is determined to be the SLC and the TLC. On the other hand, when the write data amount (s[MB]) is greater than the sum of the free capacity (x[MB]) that is writable in the SLC and the free capacity (y[MB]) that is writable in the TLC (NO in Step S2), the process proceeds to the next step.

Next, it is determined whether the write data amount (s[MB]) is writable in the TLC (Step S3). When the write data amount (s[MB]) is equal to or less than the free capacity (y[MB]) that is writable in the TLC (y≥s) (YES in Step S3), the write mode is determined to be the TLC. On the other hand, when the write data amount (s[MB]) is greater than the free capacity (y[MB]) that is writable in the TLC (NO in Step S3), the process proceeds to the next step.

Next, it is determined whether the write data amount (s[MB]) is writable in the TLC and the QLC (Step S4). When the write data amount (s[MB]) is equal to or less than the sum of the free capacity (y[MB]) that is writable in the TLC and the free capacity (z[MB]) that is writable in the QLC (y+z≥s) (YES in Step S4), the write mode is determined to be the TLC and the QLC. On the other hand, when the write data amount (s[MB]) is greater than the sum of the free capacity (y[MB]) that is writable in the TLC and the free capacity (z[MB]) that is writable in the QLC (NO in Step S4), the process proceeds to the next step.

Next, it is determined whether the write data amount (s[MB]) is writable in the QLC (Step S5). When the write data amount (s[MB]) is equal to or less than the free capacity (z[MB]) that is writable in the QLC (z≥s) (YES in Step S5), the write mode is determined to be the QLC. On the other hand, when the write data amount (s[MB]) is greater than the free capacity (z[MB]) that is writable in the QLC (NO in Step S4), the write mode is determined to be a mode in which the garbage collection (GC) processing is executed in the QLC. Here, the method of determining the free capacity that is writable can be changed in the respective determination process. In other words, the free capacity (y[MB]) that is writable in the TLC in Step S3 can be greater than the free capacity (y[MB]) that is writable in the TLC in Step S2. Also, the free capacity (z[MB]) that is writable in the QLC in Step S5 can be greater than the free capacity (z[MB]) that is writable in the QLC in Step S4.

FIG. 6 shows an example in which the write mode is selected from any of SLC, TLC, QLC, SLC and TLC, TLC and QLC, or QLC and GC by the write performance optimization processing. However, the present disclosure is not limited to this, and the write mode may be SLC and QLC, or may be SLC, TLC, and QLC. In addition, a combination including an MLC may be used. In this case, it is preferable that the information processing system 1 determines the write mode to execute the fastest write operation.

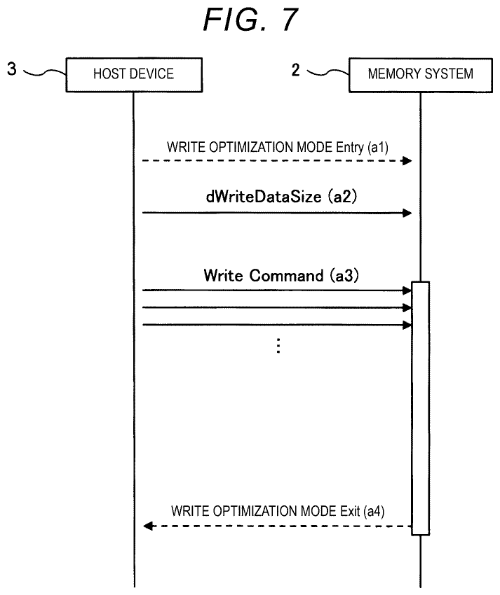

Next, an operation of the write performance optimization processing will be described with reference to FIG. 7. FIG. 7 is a diagram showing an example of the operation sequence of the information processing system 1 according to the present embodiment.

First, the host device 3 issues a command to the memory system 2 to enter a write optimization mode (a1). At this time, the host device 3 writes the write data amount (s[MB]) to the dWriteDataSize of the register 45, for example, to notify the memory system 2 (a2).

The memory system 2 receiving the command from the host device 3 reads the write data amount (s[MB]) written in the dWriteDataSize of the register 45 and the capacity of the free area of the memory cell array 108, and determines an optimal write mode. The memory system 2 selects the optimal write mode in the order of S1 to S5 in FIG. 6 so that data is written to the memory cell array 108 in a write mode as early as possible.

The host device 3 starts issuing a write command for instructing writing of the write data (a3). In this case, the host device 3 repeatedly issues the write command until all the write data is transmitted without understanding in what write mode the data is written to the memory cell array 108 in the memory system 2.

On the other hand, the memory system 2 performs writing in the optimal write mode determined according to the write command from the host device 3. After the writing is completed, the memory system 2 transmits a response message for exiting the write optimization mode (a4).

In the present embodiment, a configuration is shown in which the memory system 2 starts the write performance optimization processing by the host device 3 transmitting a command for entering the write optimization mode to the memory system 2. However, the present disclosure is not limited to this. The host device 3 may designate and notify the memory system 2 to process the write command in the write optimization mode, and may notify the memory system 2 to process in the write optimization mode by using a method other than a method of transmitting a command for entering the write optimization mode to the memory system 2. In this case, it may be possible to control the write optimization mode and the normal write mode for each write command.

In addition, internal background processing such as garbage collection (GC) processing may not be performed during the optimization mode. With such a configuration, it is possible to further improve the write performance.

In addition, the host device 3 may have a configuration in which a flag for canceling or stopping the optimization mode is set in the memory system 2. With such a configuration, the write performance optimization processing may not be performed depending on the free capacity and the write data amount of the memory cell array 108 for each write mode.

In the present embodiment, by performing the write performance optimization processing, it is possible to determine the optimal write mode by comparing the write data amount (s[MB]) with the free capacity of the memory cell array 108. Therefore, it is possible to provide an information processing system with improved write performance.

### Modification Example

In a modification example, when an additional write command comes during the operation of the write performance optimization processing according to the first embodiment, the memory system 2 totals two write data amounts and then performs the write performance optimization processing.

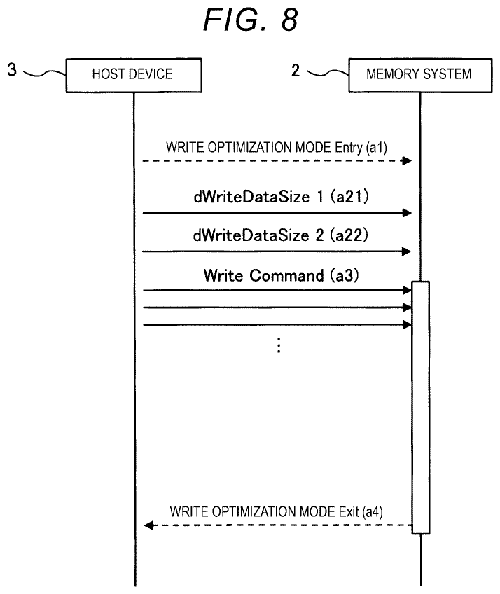

FIG. 8 is a diagram showing an example of an operation sequence of the information processing system 1 according to the present modification example. The operation of the write performance optimization processing according to the modification example is the same as the operation of the write performance optimization processing according to the first embodiment, except that the host device 3 writes two write data amounts (s[MB]) to dWriteDataSize (a21, 22), and thus the description thereof is omitted.

The memory system 2 receiving two commands from the host device 3 reads the sum of two write data amounts written in the dWriteDataSize of the register 45, and the capacity of the free area of the memory cell array 108, and determines an optimal write mode. The memory system 2 selects the optimal write mode in the order of S1 to S5 in FIG. 6 so that data is written to the memory cell array 108 in a write mode as early as possible.

In the present modification example, an example is shown in which the memory system 2 waits for a predetermined time for the write data amount (s[MB]) when the memory system 2 receives a command to enter the write optimization mode from the host device 3 (a1). Therefore, before the first write command is issued (a3), the second write data amount is written to dWriteDataSize (a22). However, the present disclosure is not limited to this, and for example, after the first write command is issued (a3), the second write data amount may be written to dWriteDataSize (a22). In this case, the memory system 2 may read the sum of two write data amounts at that time point and the capacity of the free area of the memory cell array 108, and determine the optimal write mode. The memory system 2 selects the optimal write mode in the order of S1 to S5 in FIG. 6 so that data is written to the memory cell array 108 in a write mode as early as possible.

### Second Embodiment

Since the structural configuration of the information processing system according to a second embodiment is the same as the structural configuration of the information processing system according to the first embodiment, the description thereof is omitted. In the first embodiment, the host device 3 notifies the memory system 2 of the write data amount (s[MB]), and the memory system 2 performs the write performance optimization processing. In the second embodiment, the memory system 2 notifies the host device 3 of the capacity of the free area of the memory cell array 108, and the host device 3 performs the write performance optimization processing. Since the write performance optimization processing method according to the second embodiment is the same as the write performance optimization processing method according to the first embodiment, the description thereof is omitted, and an operation of the write performance optimization processing is described.

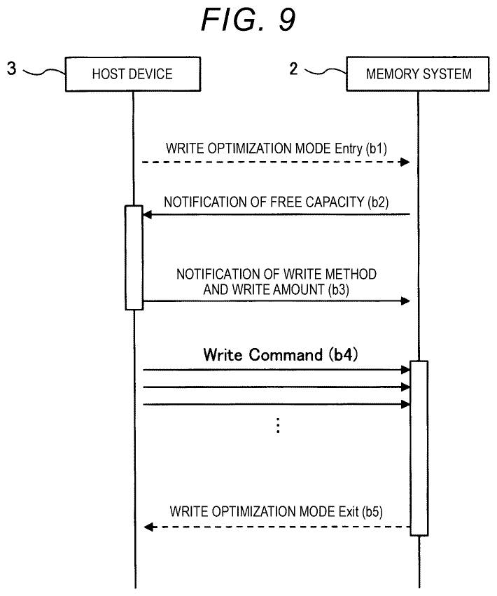

The operation of the write performance optimization processing will be described with reference to FIG. 9. FIG. 9 is a diagram showing an example of the operation sequence of the information processing system 1 according to the present embodiment.

First, the host device 3 issues a command to the memory system 2 to enter a write optimization mode (b1).

The memory system 2 receiving the command from the host device 3 reads the capacity of the free area of the memory cell array 108 stored in the RAM 44 and notifies the host device 3 thereof (b2). The capacity of the free area of the memory cell array 108 includes a physical address of a block and the free capacity of the block for each write mode. In addition to the free capacity for each write mode, the write speed under a predetermined situation may also be notified. Although the write speed for each write mode is a fixed value, for example, when the capacity of the free area of the memory cell array 108 is insufficient and the garbage collection (GC) processing becomes necessary, the write speed varies depending on the situation. The memory system 2 may calculate the write speed at the time of the garbage collection (GC) processing based on the write mode at that time and notify the host device 3 of the write speed.

The memory system 2 receiving the command from the host device 3 may read the capacity of the free area of the memory cell array 108 stored in the RAM 44 and store (or update) the read capacity of the free area of the memory cell array 108 in the register 45. In addition to the free capacity for each write mode, the write speed for each write mode may also be stored in the register 45. In this case, the host device 3 reads the capacity and write speed of the free area of the memory cell array 108 stored in the register 45, and thereby the host device 3 specifies the capacity and the write speed of the free area of the memory cell array 108.

The host device 3 determines an optimal write mode from the write data amount (s[MB]) to be written and the capacity of the free area of the memory cell array 108 received from the memory system 2. The host device 3 may determine an optimal write mode from the write data amount (s[MB]) to be written, the capacity of the free area of the memory cell array 108 received from the memory system 2, and the write speed under a predetermined situation. The host device 3 selects the optimal write mode in the order of S1 to S5 in FIG. 6 so that data is written to the memory cell array 108 in a write mode as early as possible. The host device 3 may determine an optimal write mode from the write data amount (s[MB]) to be written, the capacity of the free area of the memory cell array 108 received from the memory system 2, and the write speed for each write mode. The host device 3 notifies the memory system 2 of the write data amount (s[MB]) to be written and the determined optimal write mode (b3).

The host device 3 starts issuing a write command for instructing writing of the write data (b4).

On the other hand, the memory system 2 performs writing in accordance with an optimal write mode and the write command from the host device 3. After the writing is completed, the memory system 2 transmits a response message for exiting the write optimization mode (b5).

In the present embodiment, a configuration in which the memory system 2 receives a command for entering the write optimization mode from the host device 3, and thereby the memory system 2 reads the capacity of the free area of the memory cell array 108 stored in the RAM 44 is shown. However, the present disclosure is not limited to this, and the memory system 2 may periodically read the capacity of the free area of the memory cell array 108 stored in the RAM 44 and store (update) the capacity of the free area of the memory cell array 108 read in the register 45. In this case, a command for entering the write optimization mode may not be necessary, the memory system 2 may read the capacity of the free area of the memory cell array 108 stored in the register 45, and the host device 3 may read the capacity of the free area of the memory cell array 108 stored in the register 45.

In the present embodiment, a configuration in which the host device 3 notifies the memory system 2 of the write data amount (s[MB]) and the determined optimal write mode is shown. However, the present disclosure is not limited to this, and the host device 3 may notify the memory system 2 by designating the determined optimal write mode with the write command, or may notify the memory system 2 of the determined optimal write mode by using another method. In this case, it may be possible to control the write optimization mode and the write normal mode for each write command.

While certain embodiments have been described, these embodiments have been presented by way of example only, and are not intended to limit the scope of the disclosure. Indeed, the novel embodiments described herein may be embodied in a variety of other forms; furthermore, various omissions, substitutions, and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A memory system comprising:
a non-volatile memory having a plurality of blocks, each of the blocks including a plurality of memory cells; and
a memory controller configured to:
set one of a plurality of writing modes including a first writing mode of writing a single bit of data per memory cell and a second writing mode of writing multi bits of data per memory cell as a data writing mode for each of one or more blocks of the non-volatile memory;
upon receiving information indicating a size of write data to be written into the non-volatile memory from a host device, determine whether the size of the write data exceeds a size of a first free space of the non-volatile memory usable for data writing in the first writing mode; and
upon determining that the size of the write data exceeds the size of the first free space, write at least a part of the write data into the non-volatile memory in the second writing mode.

2. The memory system according to claim 1, wherein the memory controller is further configured to:
upon determining that the size of the write data does not exceed the size of the first free space, write entirety of the write data into the non-volatile memory in the first writing mode.

3. The memory system according to claim 1, wherein the memory controller is further configured to:
upon determining that the size of the write data exceeds the size of the first free space, determine whether the size of the write data exceeds a sum of the size of the first free space and a size of a second free space of the non-volatile memory usable for data writing in the second writing mode; and
upon determining that the size of the write data does not exceed the sum of the size of the first free space and the size of the second free space, write a first part of the write data into the non-volatile memory in the first writing mode and a second part of the write data into the non-volatile memory in the second writing mode.

4. The memory system according to claim 1, wherein
the second writing mode is of writing first multi bits of data per memory cell, and the plurality of writing modes further includes a third writing mode of writing second multi bits of data per memory cell, the second multi bits being greater than the first multi bits, and
the memory controller is further configured to:
determine whether the size of the write data exceeds a size of a second free space of the non-volatile memory usable for data writing in the second writing mode; and
upon determining that the size of the write data exceeds the size of the second free space, write at least a part of the write data into the non-volatile memory in the third writing mode.

5. The memory system according to claim 4, wherein the memory controller is further configured to, upon determining that the size of the write data does not exceed the size of the second free space, write entirety of the write data into the non-volatile memory in the second writing mode.

6. The memory system according to claim 4, wherein the memory controller is further configured to:
upon determining that the size of the write data exceeds the size of the second free space, determine whether the size of the write data exceeds a sum of the size of the second free space and a size of a third free space of the non-volatile memory usable for data writing in the third writing mode; and
upon determining that the size of the write data does not exceed the sum of the size of the second free space and the size of the third free space, write a first part of the write data into the non-volatile memory in the second writing mode and a second part of the write data into the non-volatile memory in the third writing mode.

7. The memory system according to claim 6, wherein the memory controller is further configured to, upon determining that the size of the write data exceeds the sum of the size of the second free space and the size of the third free space, write entirety of the write data into the non-volatile memory in the third writing mode.

8. The memory system according to claim 4, wherein the first multi bits are three bits and the second multi bits are four bits.

9. The memory system according to claim 1, wherein the memory controller is further configured to:
categorize each of one or more of the plurality of blocks that store valid data as an active block and each one or more of the plurality of blocks that store no valid data and has no write mode set as a free block; and
maintain capacity information that indicates a free space of one or more active blocks with respect to each of the plurality of writing modes and a capacity of one or more free blocks.

10. The memory system according to claim 9, wherein the memory controller is further configured to determine the first free space of the non-volatile memory based on the maintained capacity information.

11. The memory system according to claim 1, wherein the information indicating the size of write data to be written into the non-volatile memory is a sum of a size of first write data to be written indicated by a first notification from the host device and a size of second write data to be written indicated by a second notification from the host device after the first notification.

12. An information processing system comprising:
a host device; and
a memory system including a non-volatile memory having a plurality of blocks, each of the blocks including a plurality of memory cells, and a memory controller, wherein
the memory controller is configured to:
set one of a plurality of writing modes including a first writing mode of writing a single bit of data per memory cell and a second writing mode of writing multi bits of data per memory cell as a data writing mode for each of one or more blocks of the non-volatile memory; and
maintain, in a register of the memory system, a size of a first free space of the non-volatile memory usable for data writing in the first writing mode and a size of a second free space of the non-volatile memory usable for data writing in the second writing mode, and
the host device is configured to:
obtain, from the register of the memory system, the size of the first free space and the size of the second free space; and
based on the size of a first free space and the size of the second free space obtained from the register, issue one or more write commands to write first write data having a size within the size of the first free space in the first writing mode and second write data having a size within the size of the second free space in the second writing mode.

13. The information processing system according to claim 12, wherein the one or more write commands include a first write command to write the first write data in the first write mode and a second write command to write the second write data in the second write mode.

14. The information processing system according to claim 13, wherein the host device is configured to notify the memory controller of the writing mode to be employed for the first write data in advance of the first write command, notify the memory controller of the writing mode to be employed for the second write data in advance of the second write command.

15. The information processing system according to claim 12, wherein the memory controller is further configured to update the size of the first free space and the size of the second free space maintained in the register, in response to a command from the host device.

16. The information processing system according to claim 12, wherein the memory controller is further configured to transmit the size of the first free space and the size of the second free space maintained in the register to the host device, in response to a command from the host device.

17. The information processing system according to claim 12, wherein
the memory controller is further configured to maintain, in the register, a first speed of data writing in the first write mode and a second speed of data writing in the second write mode, and
the host device is configured to:
read, from the register of the memory system, the first speed and the second speed; and
issue the one or more write commands based also on the first speed and the second speed.

18. The information processing system according to claim 12, wherein
the memory controller is further configured to notify the host device of a write speed experienced during a garbage collection, and
the host device is configured to issue the one or more write commands based also on the write speed experienced during the garbage collection.

19. The information processing system according to claim 12, wherein
the memory controller is configured to operate in a first operational mode in which the host device is capable of designating the writing mode and a second operational mode in which the host device is not capable of designating the writing mode, and
the host device is configured to obtain the size of the first free space and the size of the second free space in the first operational mode, but not in the second operational mode.

20. The information processing system according to claim 12, wherein the host device and the memory system operate in accordance with a Universal Flash Storage (UFS) standard.
